(19) United States
(12) Patent Application Publication
(10) Pub. No.: US 2012/0305205 A1
(43) Pub. Date: Dec. 6, 2012

(54) SHADING SYSTEM, MOTOR VEHICLE AND RELATED METHOD

(75) Inventors: Frank ANNAWALD, Langen (DE); Bernd WEBER, Nauheim (DE)

(73) Assignee: GM GLOBAL TECHNOLOGY OPERATIONS LLC, Detroit, MI (US)

(21) Appl. No.: 13/483,403

(22) Filed: May 30, 2012

(30) Foreign Application Priority Data
May 31, 2011 (DE) 10 2011 102 890.4

(51) Int. Cl. B60J 3/02; B23P 11/00

(52) U.S. Cl. 160/370.21; 29/428

(57) ABSTRACT

A shading system in accordance with an exemplary embodiment is provided. The shading system includes a roof guiding arrangement and a shading arrangement movable into various shading positions in the roof guiding arrangement so as to variably shade a passenger compartment. A restraining arrangement is configured to restrain the shading arrangement independently of position and/or as a function of acceleration to prevent an unintended shifting of the shading arrangement.

### CROSS-REFERENCE TO RELATED APPLICATION

This application claims priority to German Patent Application No. 10 2011 102 890.4, filed May 31, 2011, which is incorporated herein by reference in its entirety.

### TECHNICAL FIELD

The technical field generally relates to a shading system, in particular an overhead shading system for a motor vehicle, comprising a shading arrangement that can be moved into various shading positions in a roof guiding arrangement so as to variably shade a passenger compartment.

### BACKGROUND

Shading systems for motor vehicles are known in the art. In simple configurations, the shading systems are designed as foldable sun visors or openable and closable sunshades on a roof region of the motor vehicle. Also known are shading systems in the form of slidable shading modules, above all in (sun) light-permeable panoramic ceiling vehicle roofs. These slidable shading modules are mounted in lateral rails on the motor vehicle roof. Depending on how the sunlight falls inside the motor vehicle, the shading modules can be aligned in any shading positions desired along a longitudinal axis of the motor vehicle, wherein the vehicle roof itself is not opened. In case of an accident involving the motor vehicle or generally in the event of high, abrupt negative accelerations acting on the motor vehicle, the shading module moves unimpeded and uncontrolled along the rails in the acceleration direction, and no longer is held by one end of the rails. As a result, the shading module is thrown into the interior along the windshield of the motor vehicle, and/or smashes through the windshield. This uncontrollable reaction poses an enormous risk to the vehicle passengers in case of an accident. No known solutions for preventing this uncontrolled movement or restraining a shading module have thus far come to light.

U.S. Pat. No. 4,363,515 describes a sunroof for motor vehicles with a rigid slide cover, which seals a roof opening in the closed position, and can be lowered out of the latter and slid under the fixed rear roof section. The slide cover opens the vehicle roof The sunroof is characterized in that the slide cover is provided with a collision safeguard to prevent the at least partially opened slide cover from unintentionally closing. In an embodiment, the collision safeguard is designed as at least one automatic safety belt extending between the slide cover and fixed roof section.

Therefore, at least one object herein is to provide a securing system for shading systems for vehicle roofs, which permits a restraint of the shading module given exposure to strong accelerations, and hence also prevents an uncontrolled hurling of the shading system, thereby ensuring that the vehicle passengers are protected. Other objects are to provide a motor vehicle as well as a related method. In addition, other objects, desirable features and characteristics will become apparent from the subsequent summary and detailed description, and the appended claims, taken in conjunction with the accompanying drawings and this background.

### SUMMARY

A shading system, in particular an overhead shading system for a motor vehicle, is provided. The overhead shading system comprises a shading arrangement for variably shading a passenger compartment that can be moved into different shading positions in a roof guiding arrangement. The system incorporates the technical solution in which at least one restraining arrangement is provided to restrain the shading arrangement independently of position and/or as a function of acceleration, so as to thereby prevent an unintended shifting of the shading arrangement.

In case of an accident, during which strong, negative accelerations act on the shading arrangement, such a shading system is protected against the shading arrangement being uncontrollably shifted and potentially thrown out of the motor vehicle as a result of the shading arrangement not being restrained in the guiding arrangement. This increases passenger safety. The shading arrangement does not damage or destroy the guiding arrangement at a front end. The material outlay or costs are reduced. The shading system or guiding arrangement can be used repeatedly for restraining purposes, and need not be replaced due to possible damages after a single event involving the occurrence of high negative accelerations.

In an exemplary embodiment, the shading arrangement is configured so that it can slide in two directions along a closed vehicle roof, for example a panoramic ceiling. To this end, the shading arrangement is slidably mounted in the guiding arrangement. Sliding is performed by hand in one embodiment, and electrically powered or motorized in another embodiment. By sliding the shading arrangement, it can be set to different shading positions. Adjustment of the shading positions is rasterized in one embodiment, and continuous in another embodiment. During this type of controlled and intentional shifting of the shading arrangement, comparatively low accelerations act on the shading arrangement. In this case, the restraining arrangement does not respond, and the shading arrangement can slide.

However, as soon as the acceleration forces acting on the shading arrangement reach or exceed a specifically defined level, and the acceleration takes place abruptly and suddenly, the restraining arrangement responds, and prevents an uncontrolled and unintentional shifting of the shading arrangement. The restraining function of the restraining arrangement is configured to be equally effective in each shading position of the shading arrangement. The accelerations described within the framework described herein are accelerations that arise in the shifting direction of the shading arrangement.

The shading arrangement is configured as a single piece in one embodiment, and consists of multiple pieces, i.e., at least two pieces, in another embodiment. For example, the shading arrangement encompasses a shading unit and at least two, bilaterally-situated guiding units for slidable mounting in the guiding arrangement.

The guiding arrangement is configured as a single piece in one embodiment, for example, as a continuous frame. In another embodiment, the guiding device consists of multiple pieces, i.e., at least two pieces.

An embodiment of the shading system here provides that the guiding arrangement exhibit a rail unit for the guided shifting of the shading arrangement. For example, the rail units are designed as guiding rails. In an embodiment comprised of at least two pieces, for example, the guiding arrangement encompasses two parallel running rail units for mounting the shading arrangement. Alternatively, the rail units are situated so as to converge toward each other. In such an embodiment, the shading arrangement encompasses a compensating unit for offsetting the changing distance between the rail units.

One embodiment of the guiding arrangement provides a rasterizing arrangement, so as to enable an intentional, controlled and rasterized shifting of the shading arrangement or adjustment of the shading positions. The rasterizing arrangement presets different shading positions for the shading arrangement. In another embodiment, rasterizing takes place continuously. For example, the rasterizing means are configured as latching elements in the form of nubs, impressions, clips, openings, thickened material regions, etc.

An embodiment of the shading system provides that the restraining arrangement encompasses at least one belt system resembling a seat belt system with an unwindable belt. Seat belt systems ensure that persons are restrained during sudden accelerations of the vehicle, preferably during negative accelerations. However, a movement is possible up to a specific acceleration level. The restraint only takes place once a defined acceleration level has been reached or exceeded. In particular, the belt system encompasses a belt that can be unwound from an unwinding section. Several belts are provided in one embodiment.

Correspondingly, an embodiment provides that the restraining arrangement with the unwindable belt is fixedly connected to the shading arrangement belt. One end of the belt system of the restraining arrangement is affixed to the shading arrangement in a crash-proof manner. The shading arrangement is here joined with the belt system, in particular the belt, at only a single attachment site. Another end of the belt system is secured to the guiding arrangement so that it can be moved, for example, rolled off. One embodiment of the restraining arrangement provides a belt system, while another embodiment provides two belt systems. The belt systems are structurally identical. A single belt system is situated on the shading arrangement to ensure a uniform distribution of forces in the middle of the latter. Two belt systems are located outside of the middle on the side of the shading arrangement for this very reason, preferably on the edge regions. The belt systems or belts of the belt systems are here connected with a shading arrangement. In one embodiment with a belt system, the belt system is connected with the shading arrangement. In another embodiment with more than one belt system, for example, two or three belt systems, the two or three belt systems are also just connected with the shading system. The belt systems are here connected with the shading arrangement at a single respective attachment site.

In an embodiment, a belt system encompasses a belt, a retraction mechanism and a belt tightening system. The belt constitutes the actual connection between the shading arrangement and guiding arrangement. In one embodiment, the belt is preferably flat, inelastic and tear-resistant in design, for example made out of a synthetic material. In another embodiment, the belt consists of an at least partially transparent material so as to give passengers as unimpeded a view out of a panoramic ceiling as possible. In particular, the belt is situated underneath the roof of a motor vehicle, for example a panoramic ceiling, nearly parallel to the roof, meaning without any additional deflections or directional changes in course. The belt is configured so that it can be rolled up with a retraction mechanism, so that an unrolled length of the belt can always be adjusted to the respective shading position of the shading arrangement, and the belt is preferably advantageously tight. The retraction mechanism is preferably rigidly connected with the guiding arrangement. In other embodiments, the retraction mechanism or unwinding section is fixed in place on the motor vehicle, for example, secured to a roof or motor vehicle structural support. While the shading arrangement is being controllably and slowly shifted, the retraction mechanism makes it possible to automatically deploy and retract the belt. Starting at a specific, abrupt force exerted on the retraction mechanism via the belt and shading arrangement, the latter blocks the belt so it cannot unwind, thereby preventing the uncontrolled movement of the shading arrangement. For example, the belt can also be configured as a belt strap or cable.

Another embodiment of the shading system provides that the restraining arrangement encompass one or more brake systems resembling a centrifugal clutch and/or cable brake. In one embodiment, the restraining arrangement encompasses a belt system resembling a seat belt system, and a brake system resembling a centrifugal clutch and/or cable brake. In another embodiment, the restraining arrangement encompasses only the brake system resembling a centrifugal clutch and/or cable brake. The belt system and brake system, i.e., the centrifugal clutch and cable brake, are equivalent. The restraining arrangement has a redundant design, meaning it exhibits at least two components, for example, a belt system and centrifugal clutch or cable brake, or alternatively a centrifugal clutch and a cable brake. In an embodiment with two belt systems, it is correspondingly advantageous to provide at least one centrifugal clutch and/or at least one cable brake. One embodiment provides that a brake system be configured as a radial or tangential centrifugal clutch and/or cable brake with brake shoes on both sides.

The brake system of the restraining arrangement is situated on the belt system of the restraining arrangement, in particular the belt. The belt system and brake system are here functionally connected. It is especially advantageous for the brake system to engage the belt of the belt system.

In an embodiment of the shading system, a switch unit is configured for switching the restraining device. The restraining device can be switched on and off with the switching unit. For example, the restraining device can be switched off during maintenance work. In one embodiment, the switch unit can be coupled with an electronic unit, for example, with an acceleration sensor and/or so as to be connected with other safety arrangements, such as an airbag.

Another embodiment of the shading system provides that a cladding arrangement be furnished for at least partially cladding the guiding arrangement and/or restraining device. In one embodiment, the rail units of the guiding arrangement are at least partially clad, thereby ensuring that the guiding units of the shading arrangement will engage into the rail units, for example, through oblong slits along the rail units. In another embodiment, the restraining arrangement is at least partially clad, with at least the fixed attachment of the belt on the shading arrangement and retractable attachment on the guiding arrangement having a clad design. The brake system can be at least partially clad in design. In an embodiment of the cladding arrangement, both the guiding arrangement and restraining arrangement are clad. For example, this is possible in an embodiment of the restraining arrangement with two belt systems situated in the edge region of the rail units and optional brake systems.

Yet another embodiment of the shading system provides that the shading arrangement exhibit a sunshade unit. The sunshade unit provides additional shade to passengers. For example, the sunshade unit can be configured as a sunblind that can be rolled up and down and/or folding sun visors.

In an embodiment, the shading arrangement also exhibits a gripping unit for manual activation, i.e., for controlled and intentional forward and reverse sliding. For example, the gripping unit is a recess, lever and/or bracket.

In accordance with a further embodiment, a motor vehicle includes a sun protection system configured like the shading system described above. For example, the motor vehicle is designed as a sedan, SUV, station wagon, sports car, minivan, etc. The shading system is accommodated under a roof of the motor vehicle. For example, the roof takes the form of a translucent panoramic ceiling roof. The shading system shields the vehicle interior from incident light. To this end, the shading arrangement of the shading system is shifted into any shading position desired. The shading system is shifted along a longitudinal axis of the motor vehicle, meaning from the rear to the front of the motor vehicle, and vice versa. The roof of the motor vehicle remains closed in the process. An additional roof opening independent of the shading system is possible.

A motor vehicle equipped with the restraining arrangement of the shading system described above offers additional passenger protection. The shading arrangement remains securely mounted in the rail units of the guiding arrangement even during high negative accelerations, for example, in case of an accident, and is not hurled through the vehicle interior or even thrown out of the latter, so that passengers are not faced with any additional risk of injury.

For example, the shading system is coupled with the onboard electronics of the motor vehicle, e.g., for turning the shading system on and/or off, and/or for further coupling with other safety arrangements, such as an airbag or acceleration sensor.

In order to at least partially shade at least one passenger compartment in the motor vehicle, a method for securing a shading system, in particular a roof shading system in a motor vehicle is provided herein. The shading arrangement is prevented from shifting independently of the shading position when a predetermined acceleration level has been reached and/or exceeded. In an embodiment, the shading arrangement is restrained independently of the shading position of the shading arrangement, but as a function of acceleration as the benchmark. In particular, the acceleration is a negative acceleration, for example, when decelerating the motor vehicle. Alternatively, the benchmark involves exposure to a general force, such as momentum or velocity.

### BRIEF DESCRIPTION OF THE DRAWINGS

The various embodiments will hereinafter be described in conjunction with the following drawing figures, wherein like numerals denote like elements, and wherein:

FIG. 1 is a diagrammatic, perspective view of a shading system with restraining arrangement in a first embodiment;

FIG. 2 is a diagrammatic, perspective view of the shading system with restraining arrangement in another embodiment with detail A; and

FIG. 3 is a magnified, diagrammatic perspective view of detail A according to FIG. 2.

### DETAILED DESCRIPTION

The following detailed description is merely exemplary in nature and is not intended to limit various embodiments or the application and uses thereof. Furthermore, there is no intention to be bound by any theory presented in the preceding background or the following detailed description.

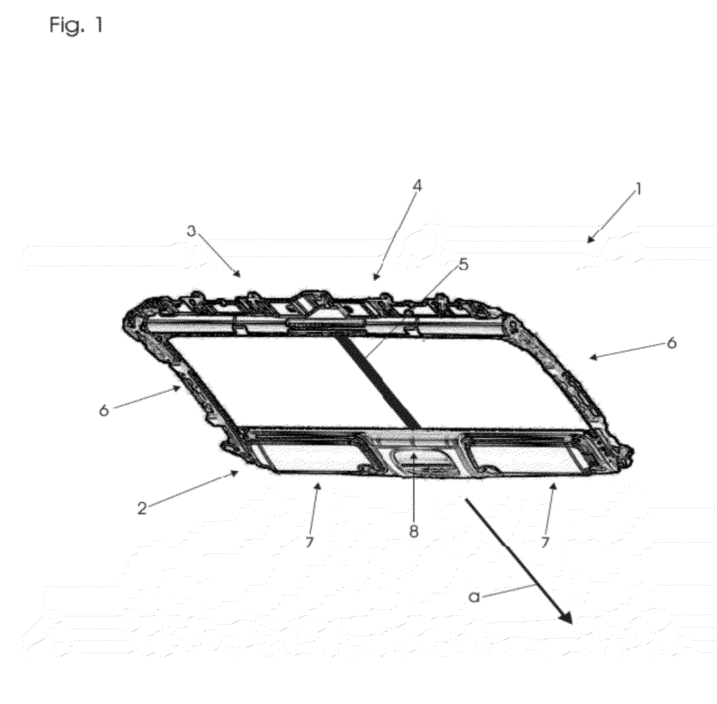

FIG. 1 shows a diagrammatic, perspective view of a shading system 1 with a restraining arrangement 4. The shading system 1 is configured as an overhead shading system for a motor vehicle (not shown). FIG. 1 depicts the shading system 1 through the eyes of a passenger, i.e., at an inclination from below. The shading system 1 encompasses a shading arrangement 2 for at least partially shading passengers (not shown) and a guiding arrangement 3 designed like a frame for accommodating and sliding the shading arrangement 2. The shading arrangement 2 is situated on the roof of the motor vehicle, wherein the guiding arrangement 3 is secured under the roof of the motor vehicle. In order to provide a better view, FIG. 1 does not show a motor vehicle or a roof of a motor vehicle. The shading arrangement 1 is bilaterally and slidably mounted in two rail units 6 of the guiding arrangement 3. For this purpose, the shading arrangement 1 exhibits the corresponding guiding units (not shown).

In addition, the shading system 1 encompasses the restraining arrangement 4 that acts independently of position and as a function of acceleration, so as to prevent an unintended shifting by the shading arrangement 2 independently of a shading position and as a function of an acceleration of the shading arrangement 2. The restraining arrangement 4 is configured as a belt system resembling a safety belt. The belt system is situated in about the middle of the shading arrangement 2 viewed in the width direction. The belt system here further encompasses an unwindable belt 5, a fixed attachment of the belt 5 to the shading arrangement 2, and a movable, i.e., roll-up and roll-down, attachment to the guiding arrangement 3, for example a retraction unit in the form of a roller. The belt 5 is joined with the shading arrangement 2 at only a single attachment site. Furthermore, the belt 5 runs nearly parallel to the roof of the motor vehicle, meaning without any additional deflections.

The belt 5 is used to restrain the shading arrangement 2 given an unintended, strong acceleration in the direction of arrow a. The shading arrangement 2 is here held independently of its shading position. This prevents the shading arrangement 2 from uncontrollably moving in its guiding means up to the end of the rail units 6 without being slowed down, destroying the latter and detaching from them.

In addition, the shading arrangement 2 also encompasses a sunshade unit 7 in the form of two folding sunshades, and a gripping unit for purposes of manually sliding forward and reverse.

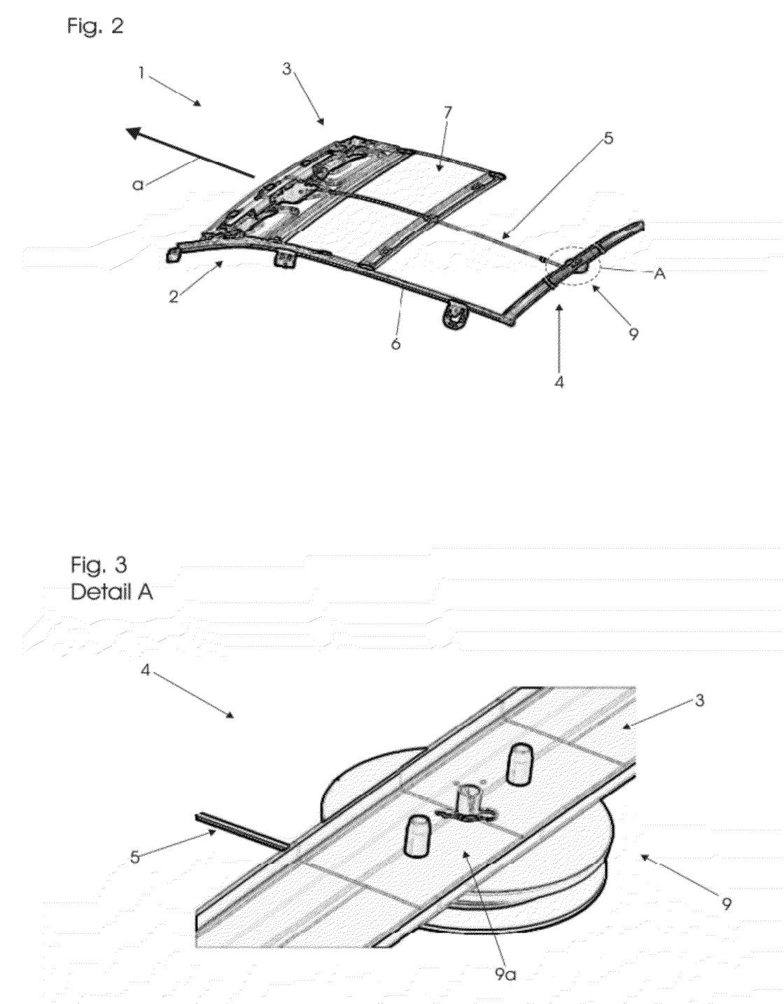

FIG. 2 shows a diagrammatic, perspective view of the shading system 1 with the restraining arrangement 4 in another embodiment with detail A. The shading system 1 on FIG. 2 basically corresponds to the shading system 1 on FIG. 1. The same components are marked with the same reference numbers. Therefore, no detailed description of components already described will be provided. The shading arrangement 2 on FIG. 2 is shown with the sunshade unit 7 rolled out. For stabilization purposes, the sunshade unit 7 is loosely connected with the belt 5 or can be rolled up and down along the latter.

The shading system 1 on FIG. 2 differs from the embodiment on FIG. 1 only with respect to the design of the restraining arrangement 4. In addition to the belt system with belt 5, the restraining arrangement 4 also encompasses a centrifugal clutch 9 as a redundancy or to exert an additional braking effect. The centrifugal clutch 9 is fixedly secured to the guiding arrangement 3. The belt 5 is functionally connected with the centrifugal clutch 9.

FIG. 3 shows a magnified, diagrammatic perspective view of detail A according to FIG. 2. Detail A depicts the centrifugal clutch 9 with its attachment to the guiding arrangement 3. The fixed attachment is configured as a safety plug-in attachment 9a. The safety plug-in attachment 9a is inserted into three holes in the guiding arrangement 3, and secured once with a bolt. The centrifugal clutch 9 exhibits a round, flat housing with a quill and a rotatable mount, for example, one configured as an unwinding roller (not shown in detail here).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A shading system comprising:
a roof guiding arrangement;
a shading arrangement movable into various shading positions in the roof guiding arrangement so as to variably shade a passenger compartment; and
a restraining arrangement configured to restrain the shading arrangement independently of position and/or as a function of acceleration to prevent an unintended shifting of the shading arrangement.

2. The shading system according to claim 1 wherein the shading system is an overhead shading system for a motor vehicle.

3. The shading system according to claim 1, wherein the roof guiding arrangement has a rail unit for the guided shifting of the shading arrangement.

4. The shading system according to claim 1, wherein the restraining arrangement has a belt system resembling a safety belt system with an unwindable belt.

5. The shading system according to claim 4, wherein the restraining arrangement with the unwindable belt is fixedly connected to the shading arrangement.

6. The shading system according to claim 1, wherein the restraining arrangement has a brake system comprising a centrifugal clutch and/or a cable brake.

7. The shading system according to claim 1, wherein a switching unit is configured to switch the restraining arrangement.

8. The shading system according to claim 1, the shading system further comprising a cladding arrangement configured for at least partially cladding the roof guiding arrangement and/or the restraining arrangement.

9. The shading system according to claim 1, wherein the shading arrangement has a sunshade unit.

10. A motor vehicle with a sun protection system, wherein the sun protection system is configured as a shading system comprising:
a roof guiding arrangement;
a shading arrangement movable into various shading positions in the roof guiding arrangement so as to variably shade a passenger compartment of the motor vehicle;
a restraining arrangement configured to restrain the shading arrangement independently of position and/or as a function of acceleration to prevent an unintended shifting of the shading arrangement.

11. The motor vehicle according to claim 10, wherein the roof guiding arrangement has a rail unit for the guided shifting of the shading arrangement.

12. The motor vehicle according to claim 10, wherein the restraining arrangement has a belt system resembling a safety belt system with an unwindable belt.

13. The motor vehicle according to claim 12, wherein the restraining arrangement with the unwindable belt is fixedly connected to the shading arrangement.

14. The motor vehicle according to claim 10, wherein the restraining arrangement has a brake system comprising a centrifugal clutch and/or a cable brake.

15. The motor vehicle according to claim 10, wherein a switching unit is configured to switch the restraining arrangement.

16. The motor vehicle according to claim 10, the shading system further comprising a cladding arrangement configured for at least partially cladding the roof guiding arrangement and/or the restraining arrangement.

17. The motor vehicle according to claim 10, wherein the shading arrangement has a sunshade unit.

18. A method for securing a shading system, the shading system comprising:
a roof guiding arrangement; and
a shading arrangement movable into various shading positions in the roof guiding arrangement so as to variably shade a passenger compartment;
the method comprising:
providing a restraining arrangement configured to restrain the shading arrangement independently of position and/or as a function of acceleration; and
preventing the shading arrangement from shifting independently of a shading position when a predetermined acceleration level has been reached and/or exceeded using the restraining arrangement.

19. The method according to claim 18, wherein the method is utilized for securing a roof shading system in a motor vehicle.
